(19) United States
(12) Patent Application Publication
(10) Pub. No.: US 2011/0244213 A1
(43) Pub. Date: Oct. 6, 2011

(54) CORE FOR COMPOSITE LAMINATED ARTICLE AND MANUFACTURE THEREOF

(75) Inventor: Daniel Thomas Jones, Isle of Wight (GB)

(73) Assignee: GURIT (UK) LTD., NEWPORT, ISLE OF WIGHT (GB)

(21) Appl. No.: 13/133,452

(22) PCT Filed: Dec. 7, 2009
(86) PCT No.: PCT/EP09/66553

§ 371 Date: Jun. 8, 2011

(30) Foreign Application Priority Data
Dec. 9, 2008 (GB) 0822420.6

(51) Int. Cl. B32B 3/26; B29C 70/66

(52) U.S. Cl. 428/304.4; 156/245

(57) ABSTRACT

Core for a composite laminated article, the core being a sheet having a sandwich structure including a pair of outer foam bodies and a central structural insert therebetween, the structural insert including portions that are inclined to the plane of the sheet and to the through-thickness direction of the sheet.

The present invention relates to a structural element for use as a core for a composite laminated article and to a method of making a core for a composite laminated article. The present invention also relates a composite laminated article incorporating such a core. In particular, the present invention relates to composite laminated articles and cores therefor, suitable for use in manufacturing large structures such as, for example, wind turbine blades and boat hulls, decks and bulkheads, bridges, and walkways

Some fibre reinforced composite components comprise an inner rigid foam core sandwiched between outer layers of fibre reinforced composite material. Foam cores are used extensively in the manufacture of fibre reinforced plastic parts to increase the rigidity of the finished article by separating two fibre-reinforced layers, acting as structural skins, with a low-density core material, acting as a structural core. The fibre-reinforced layers are bonded to the low-density core material by a layer of resin material. This construction is commonly called a sandwich panel in the composite industry.

The primary functions of a structural core are to increase the separation of the two fibre reinforced layers to increase panel rigidity, by reducing the overall deflection under load and onset of global panel buckling, and to prevent skin wrinkling and localised buckling. The shear modulus is main engineering property driving the core selection to prevent global panel buckling and the localised buckling effects of shear crimping and skin wrinkling, as typically seen in wind turbine shells. In the cases of structures like boat hulls, bridges and walkways, significant out of plane loads are applied to the panel. In these cases the shear strength is the engineering property most driving the core selection, usually followed by the shear modulus. The compressive strength of the core only usually becomes critical to prevent localised crushing failure modes where point loads perpendicular to the panel may be applied. Typical cases to consider would be lifting points, bolted fittings, or where the panels form part of a floor and are subject to pedestrian or vehicle loads. It is quite common to add high density core or additional materials to support these localised loads to minimise the overall weight. A high compressive modulus can also help contribute to reducing the skin wrinkling stress but for most structures the shear properties determine the minimum density of the structural core.

It is often desired to maximise the mechanical properties of the foam for a given density to enable the lightest weight core to be selected to transfer the structural loads between the fibre reinforced layers. The core must also be compatible with the materials and manufacturing process used to make structural composite skins. To achieve good properties good adhesion, using the minimum amount of resin is also required.

A variety of materials is known for the manufacture of cores to form sandwich panels. These materials can vary in shear modulus and shear strength.

Honeycomb structures, with through thickness pores, may be made of aluminium or aramid. Honeycombs have the highest specific properties of shear modulus and shear strength but are difficult to process. Due to the open cell nature it is also not possible to combine honeycombs with composite manufacturing methods such as VARTM (Vacuum Assisted Resin Transfer Moulding) as the cells simply fill with resin. Honeycombs tend to be mainly used where the highest performance is required in applications such as aerospace and racing boats with fibre-reinforced pre-preg materials.

Foam materials, which may have varying performance, tend to have lower specific properties of shear modulus and shear strength than honeycomb structures.

Structural foams are often preferred as they have a good balance of properties and processability. Some can be thermoformed to improve the fit to the required component and allow easier processing. Both skins can be cured simultaneously as the foam transfers a more even consolidation to the laminate between the mould and foam.

Low density structural foams (having a density of from 50-600 g/L) currently used in the composite industry that have the highest mechanical and thermal performance are cross-linked polyvinyl chloride (PVC) foam, styrene acrylonitrile (SAN) foam, and polymethacrylimide (PMI) foam. These known foams are made from batch processes and are both time consuming and expensive to produce. These foams have varying degrees of cross-linking making them more difficult to recycle as they cannot be re-melt processed, unlike a true 100% thermoplastic material. As they tend to be made from a batch process waste is incurred from trimming and machining into standard sheet format; both in terms of plan shape and thickness.

When the outer layers of fibre reinforced composite material are preset as pre-pregs, these foams are suitable for high temperature pre-preg processing at temperatures from 75-160° C., depending on the foam type, in which processing the foam should resist at least 1 bar vacuum pressure for extended periods of time during the pre-preg cure. Other such known foams can be used for lower temperature applications at processing temperatures of from 20-75° C., for example using resin infusion processing, which is known in the art for the manufacture of articles such as boat hulls, decks and bulkheads.

Lower cost commodity foams such as polystyrene and polyurethane do not have the specific properties, temperature and chemical resistance, or are compatible with some resins used to manufacture thermosetting composite components. These are not widely used as they do not deliver the performance required. Some of these known foams release gas during elevated temperature processing which can inhibit the cure of pre-preg materials or the pressure of the gas is such that the cause the skin “skin blow off” during processing.

Balsa wood can provide specific properties of shear modulus and shear strength which are generally lower than the best honeycomb structures (e.g. of metal) but higher than low and medium performance foams. Balsa is a porous material and has a tendency to absorb large amounts of resin during processing which add significantly to the weight and cost meaning the high specific properties are not achieved. Balsa can be prone to rot in service and has to be pre-treated to remove moisture before processing. This is critical if pre-preg is to be used as the entrapped moisture can cause “skin blow off” at elevated temperatures.

There is a general need to reduce both construction cost and component weight of composite laminated articles. When a fibre reinforced layer is to be bonded to a core layer it is necessary to provide sufficient resin in the fibre reinforced layer to enable complete bonding to the core layer. There is a need in the art for foam cores that can be securely and reliably bonded to fibre reinforced layers over the interface there between that permits a minimum amount of resin to be required for such bonding, in order to minimise the weight and material cost for achieving a given structural performance providing particular mechanical properties.

There is a need to provide a closed cell foam which assists in air removal in the pre-preg process.

There is a need to provide a closed cell foam which can first assist in air removal then increase and distribute the flow of resin to impregnate the laminate without absorbing large amounts of the resin in the VARTM (Vacuum Assisted Resin Transfer Moulding), and RTM (Resin Transfer Moulding) processes.

Furthermore, the size of foam core pieces is limited by both the foam manufacturing process and the handleability of the foam pieces, in order for operators to be able to fit the foam into the mould being used to form the composite component. It is increasingly common for a foam core to be supplied pre-machined to speed up assembly. These foam kits can be made into a jigsaw of foam parts with self assembly features, such as dog bones or serrated edges, to speed up the assembly within the mould and to provide correct positioning of the core into a complex moulding. Depending on the complexity of the core, the machining can lead to considerable amounts of foam material being wasted.

There is a general need to reduce the amount of foam core material being wasted in the manufacture of composite laminated articles.

There is a general need to increase the mechanical property performance of a foam but still provide the material as a foam body to maintain the ease of processing.

The present invention at least partially aims to meet one or more of these needs in the composite material art.

The present invention provides a core for a composite laminated article, the core comprising a sheet having a sandwich structure comprising a pair of outer foam bodies and a central structural insert therebetween, the structural insert including portions that are inclined to the plane of the sheet and to the through-thickness direction of the sheet.

Preferably, the structural insert extends in a substantially zig-zag fashion through the through-thickness of the core. The central structural insert preferably has projecting portions which extend to a major outer surface of a respective outer foam body. The structural insert may comprise a contoured sheet which has opposite major surfaces which are contoured three-dimensionally. Preferably, each major surface of the sheet has an array of projections and depressions. Preferably, the projections and depressions are substantially pyramidal. The substantially pyramidal projections and depressions preferably each have mutually orthogonally arranged inclined side faces. The pyramidal shape is truncated to form a planar top surface. The planar top surface may be level with an outer surface of the core.

The central structural insert may comprise a continuous sheet or a sheet with a plurality of through holes.

The central structural insert may comprise a thermoplastic pressing.

Alternatively, the central structural insert may comprise a sheet of interwoven fibres. Preferably, the fibres comprise a plurality of warp fibres and a plurality of weft fibres, each fibre having a non-linear longitudinal shape, having portions that are inclined to the longitudinal direction of the fibres and alternating inclined sections.

In another embodiment, the central structural insert comprises a fibre reinforcement. The central structural insert may comprise a grid composed of first and second sets of parallel tapes, the first and second sets being mutually inclined. The fibre reinforcement may comprise one or more prepreg layers, the prepreg layers comprising fibres at least partially impregnated with resin.

In another embodiment, the central structural insert comprises a foam. Preferably, the foam of the central structural insert has a density higher that the density of the foam of the outer foam bodies.

Preferably, the foam core and the structural insert are symmetrical about a central plane thereof. The sheet may be planar or curved. The or each foam is preferably a closed cell foam.

In another aspect, the present invention provides a core for a composite laminated article, the core comprising a sheet including an open grid of a first foam material having cavities, the cavities being filled with blocks of a second foam material of different density than the first foam material.

Each foam is preferably a closed cell foam.

In one embodiment, the grid is a rectangular grid which comprises integral first and second sets of mutually orthogonal webs.

In another embodiment, the grid comprises integral first, second and third sets of mutually inclined webs, the webs being mutually inclined at 0°, 45° and 90° or 0°, 60° and 120°.

Preferably, the grid is composed of higher density foam than that of the blocks.

In one embodiment, the core may further comprise a first foam skin integral with the grid on a first surface of the grid. Preferably, the core further comprises a second foam skin bonded to a second, opposite, surface of the grid and the blocks.

In another embodiment, the core may further comprise a first foam skin integral with the blocks on a first surface of the blocks. Preferably, the core further comprises a second foam skin bonded to a second, opposite, surface of the blocks and the grid.

In any embodiment, the core may further comprise at least one opening, slit or channel in an outer surface of at least one of the outer foam bodies. The core may comprise an array of parallel slits extending through a majority of the thickness of the core to permit the core to be bent around a radius having an axis parallel to the slits; an array of openings extending through the thickness of the core; or an array of slits extending through the core thereby cutting the core into a plurality of adjacent separate blocks, and further comprising a scrim layer bonded on one surface of the core thereby bonding together the blocks. Preferably, the core comprises an array of parallel slits or channels in the outer surface both of the outer foam bodies

In another aspect, the present invention provides an assembly for producing a composite laminated article, the assembly comprising the core of any foregoing claim sandwiched between opposed layers of fibre or prepreg layers, the prepreg layers comprising fibres at least partially impregnated with resin.

In a further aspect, the present invention provides a method of making a core for a composite laminated article, the method comprising the steps of;

(a) moulding a first foam body having a contoured top surface;
(b) disposing a material onto the contoured top surface; and
(c) moulding a second foam body over the material.

Preferably, the disposing step (b) comprises fowling a central foam body on the contoured top surface. Preferably, the first foam body comprises a first skin and integral portions extending upwardly therefrom to form the contoured top surface, and in step (b) the central foam body is formed in cavities formed by the integral portions, the first foam and the central foam body being respectively formed of first and second foam materials of different density. Preferably, in step (c) a second skin is formed over the first foam and the central foam body.

In one embodiment, the contoured top surface comprises a rectangular grid which comprises integral first and second sets of mutually orthogonal webs.

In another embodiment, the contoured top surface comprises a triangular grid which comprises integral first, second and third sets of mutually inclined webs, the webs being mutually inclined at 0, 45 and 90 degrees, or 0, 60 and 120 degrees.

Preferably, the material in disposing step (b) is a thermoformed, pressed or stamped sheet. Preferably, the sheet is composed of foam or chopped fibres or thermoplastic material. Preferably, the contoured sheet has opposite major surfaces which are contoured three-dimensionally.

Preferably, each major surface of the sheet has an array of projections and depressions. The projections and depressions are preferably substantially pyramidal. The substantially pyramidal projections and depressions each have mutually orthogonally arranged inclined side faces. Preferably, the pyramidal shape is truncated to form a planar top surface.

In a further aspect, the present invention provides a method of making a core for a composite laminated article, the method comprising the steps of;

(a) moulding a structural sheet material having contoured top and bottom surfaces;
(b) moulding a first foam body over the contoured bottom surface; and
(c) moulding a second foam body over the contoured bottom surface.

Preferably, the structural sheet material extends in a substantially zig-zag fashion through the through-thickness of the core. Preferably, the central structural insert has projecting portions which extend to a major outer surface of a respective outer foam body.

In a further aspect, the present invention provides a method of making a core for a composite laminated article, the method comprising the steps of:

(a) moulding a first foam body having a first contoured surface;
(b) moulding a second foam body having a second contoured surface, the first and second contoured surfaces being complementarily shaped;
(c) interlocking the first and second contoured surfaces to define a contoured cavity extending therebetween over the opposed surfaces; and
(d) forming a central structural insert in the cavity which is bonded to the first and second contoured surfaces.

Preferably, the central structural insert comprises a fibre-reinforced resin.

Preferably, the fibre-reinforced resin is formed from prepreg material, the prepreg material comprising fibres at least partially impregnated with resin. Preferably, the prepreg material is disposed on at least one of the contoured surfaces prior to interlocking step (c).

Alternatively, the fibre-reinforced resin may be formed from dry fibres disposed on at least one of the contoured surfaces prior to interlocking step (c) and in step (d) resin is introduced into the cavity.

Alternatively, the fibre-reinforced resin may be formed from fibrous reinforcement disposed within the cavity in step (c) and liquid resin introduced into the cavity in step (d) by resin transfer moulding.

Preferably, the fibres of the fibre-reinforced resin form a contoured grid.

The central structural insert may comprise a thermoplastic material. The thermoplastic material may be adhesively bonded or fusion welded to the first and second contoured surfaces.

Preferably, the structural insert extends in a substantially zig-zag fashion through the through-thickness of the core.

In a further aspect, the present invention provides a method of making a core for a composite laminated article, the method comprising the steps of;

(a) disposing into a mould a structural insert in the form of a sheet having opposite contoured surfaces; and
(b) moulding a foam over the structural insert to form a sandwich structure comprising a pair of outer foam bodies and a central structural insert therebetween.

Preferably, the structural insert comprises a sheet of interwoven fibres. The fibres preferably comprise a plurality of warp fibres and a plurality of weft fibres, each fibre having a non-linear longitudinal shape, having portions that are inclined to the longitudinal direction of the fibres and alternating inclined sections.

In any of the methods, the method may further comprise forming an array of parallel lits or channels in the outer surface both of the outer foam bodies.

Embodiments of the present invention will now be described by way of example with reference to the accompanying drawings, in which:

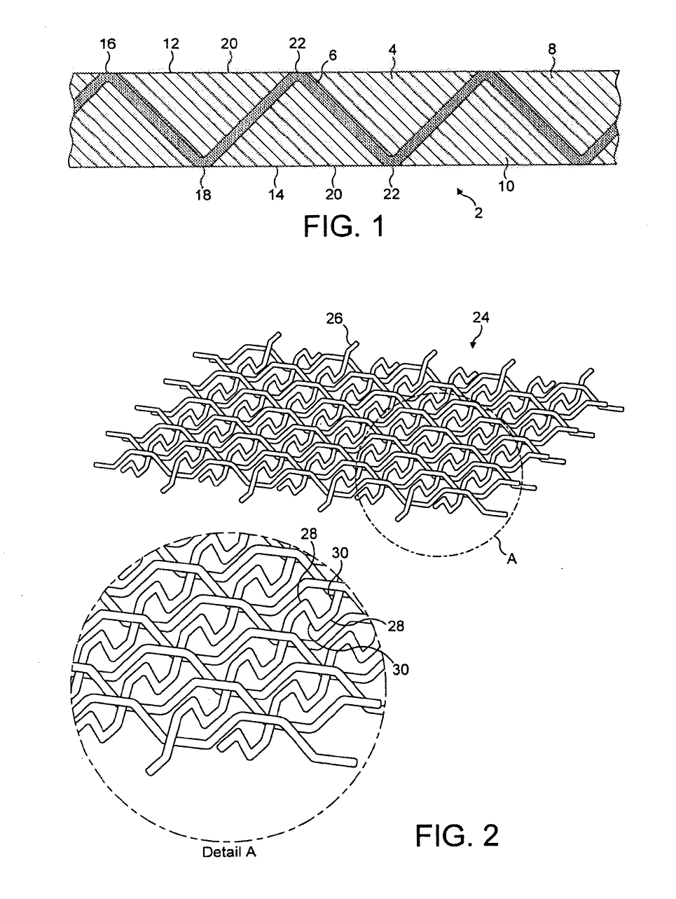

FIG. 1 is a schematic cross-section through a structural element comprising a foam in accordance with a first embodiment of the present invention;

FIG. 2 is a perspective view of a structural insert for a structural element comprising a foam in accordance with a second embodiment of the present invention;

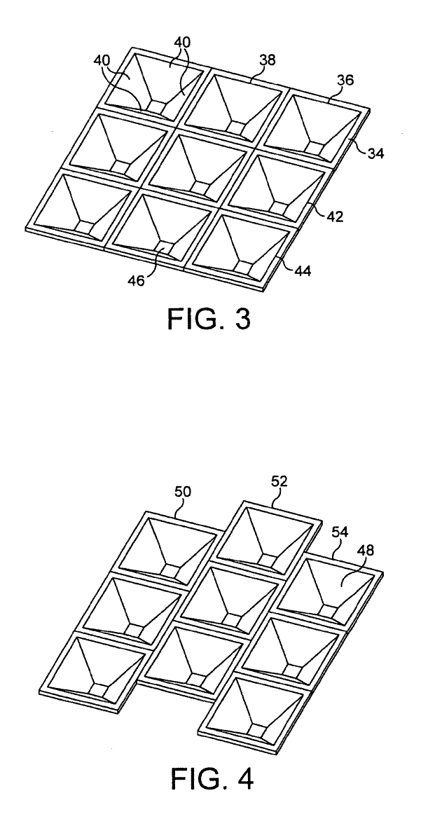

FIG. 3 is a perspective view of a structural insert for a structural element comprising a foam in accordance with a third embodiment of the present invention;

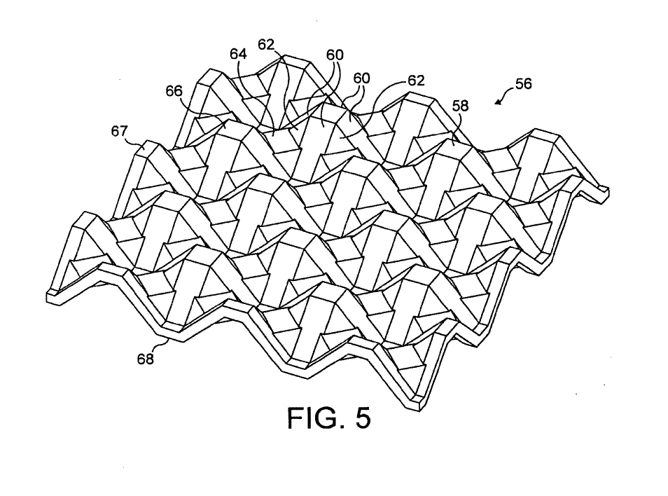

FIG. 4 is a perspective view of a structural insert for a structural element comprising a foam in accordance with a fourth embodiment of the present invention;

FIG. 5 is a perspective view of a structural insert for a structural element comprising a foam in accordance with a fifth embodiment of the present invention;

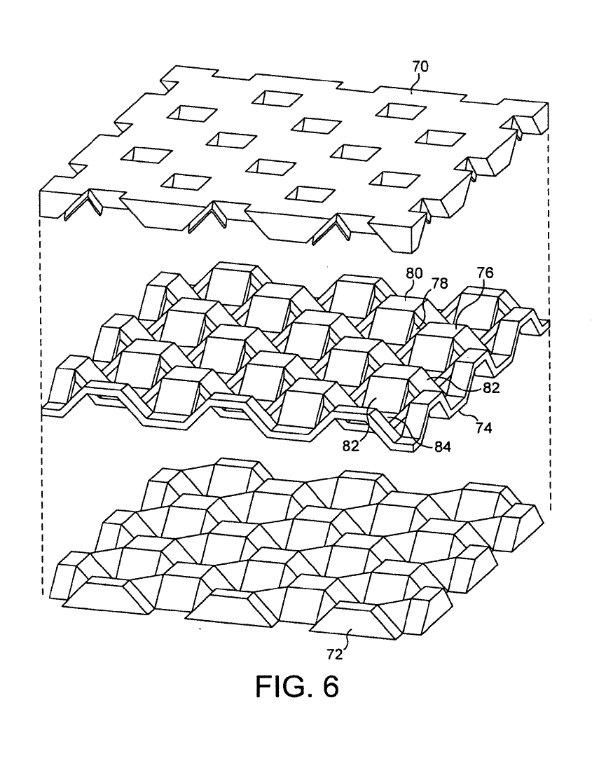

FIG. 6 is a perspective exploded view of a structural element comprising a foam in accordance with a sixth embodiment of the present invention;

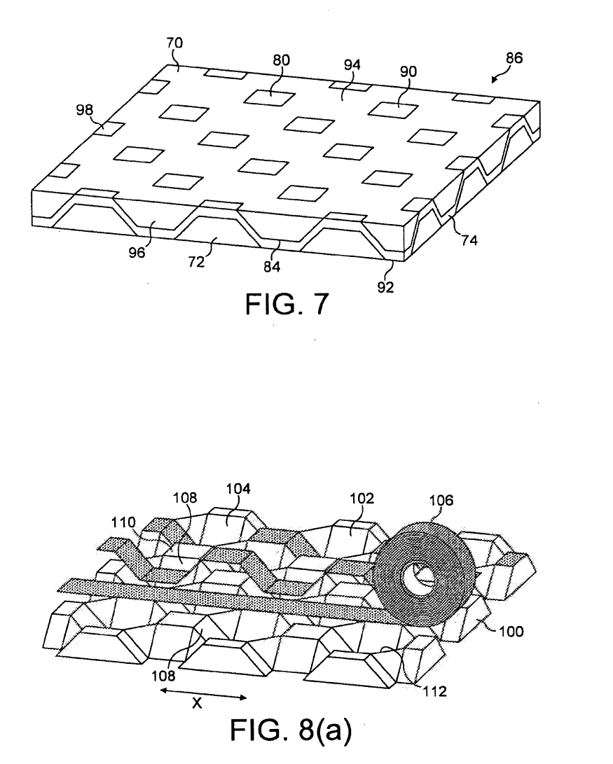

FIG. 7 is a perspective view of the structural element of FIG. 6;

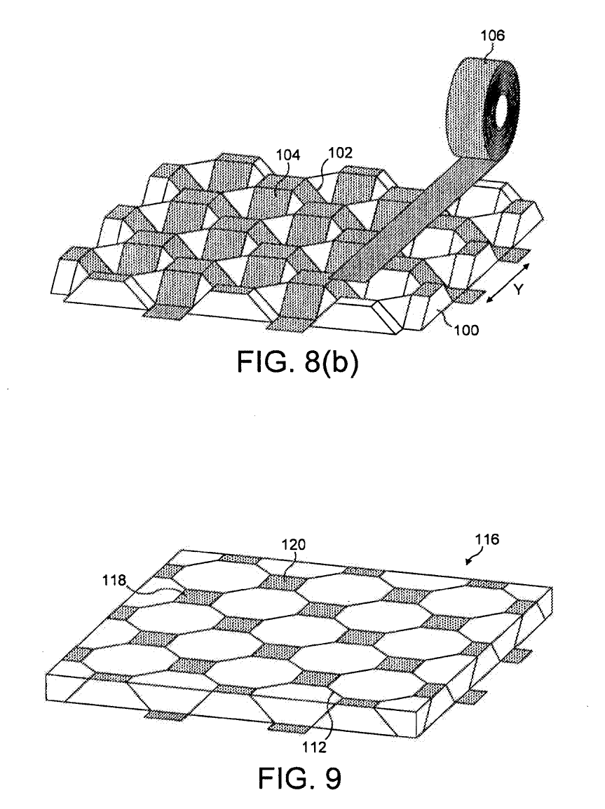

FIG. 8 is a perspective exploded view of the manufacture of a structural element comprising a foam in accordance with a seventh embodiment of the present invention;

FIG. 9 is a perspective view of the structural element produced according to FIG. 8;

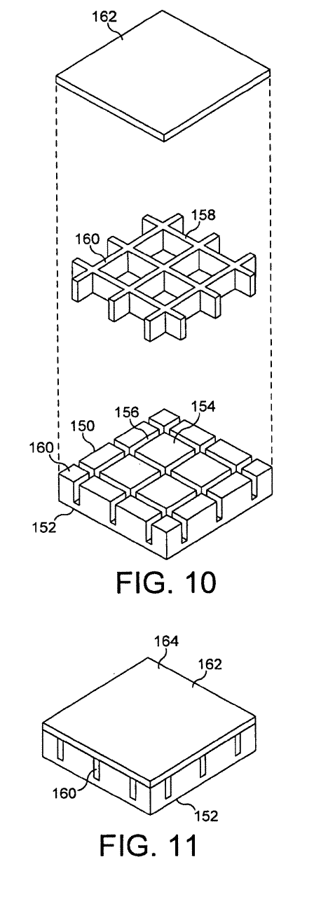

FIG. 10 is a perspective exploded view of a structural element comprising a foam in accordance with a eighth embodiment of the present invention;

FIG. 11 is a perspective view of the structural element of FIG. 10;

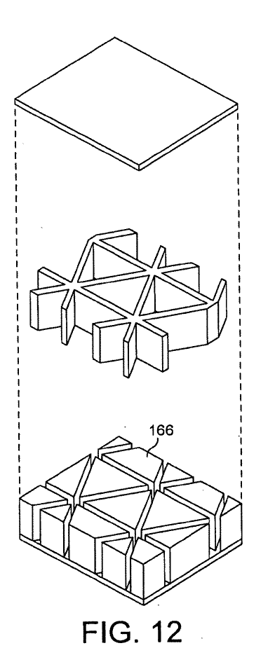

FIG. 12 is a perspective exploded view of a structural element comprising a foam in accordance with an ninth embodiment of the present invention;

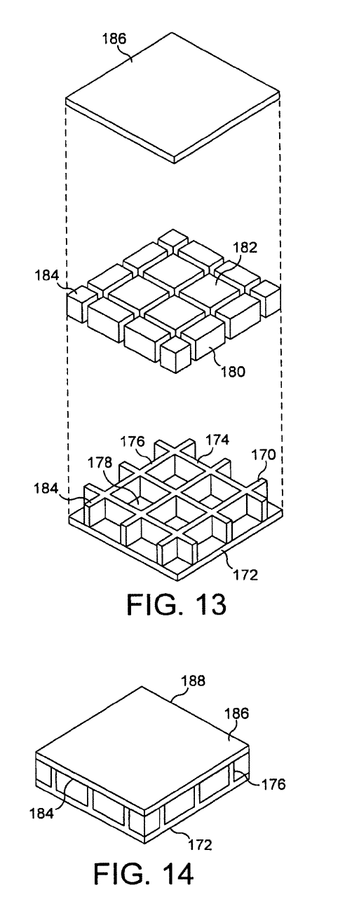

FIG. 13 is a perspective exploded view of a structural element comprising a foam in accordance with a tenth embodiment of the present invention;

FIG. 14 is a perspective view of the structural element of FIG. 13;

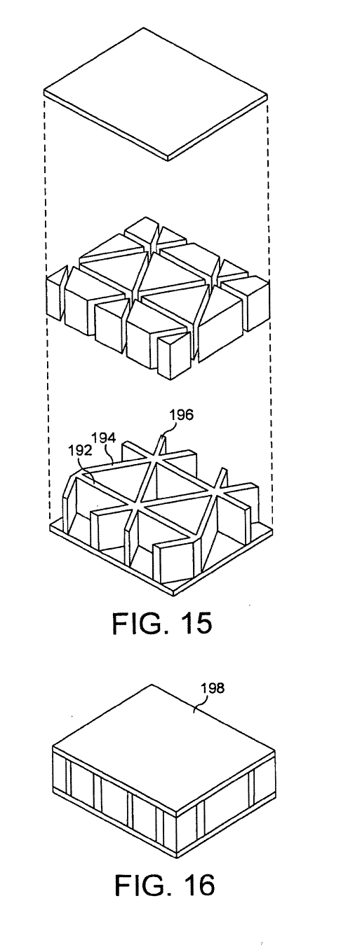

FIG. 15 is a perspective exploded view of a structural element comprising a foam in accordance with an eleventh embodiment of the present invention;

FIG. 16 is a perspective view of the structural element of FIG. 15;

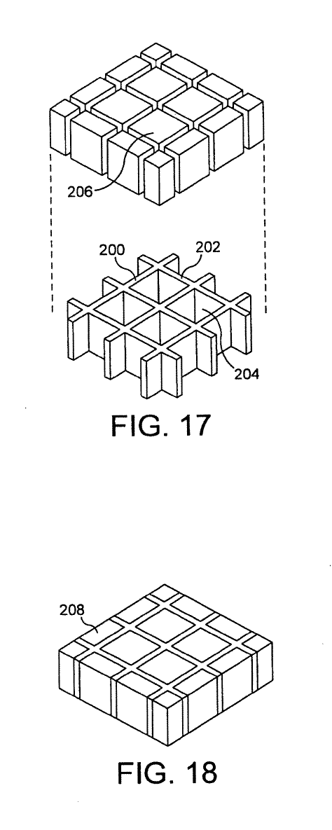

FIG. 17 is a perspective exploded view of a structural element comprising a foam in accordance with a twelfth embodiment of the present invention;

FIG. 18 is a perspective view of the structural element of FIG. 17;

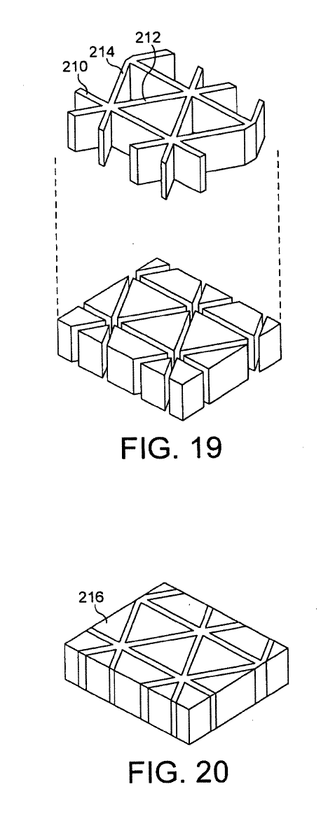

FIG. 19 is a perspective exploded view of a structural element comprising a foam in accordance with a thirteenth embodiment of the present invention;

FIG. 20 is a perspective view of the structural element of FIG. 19;

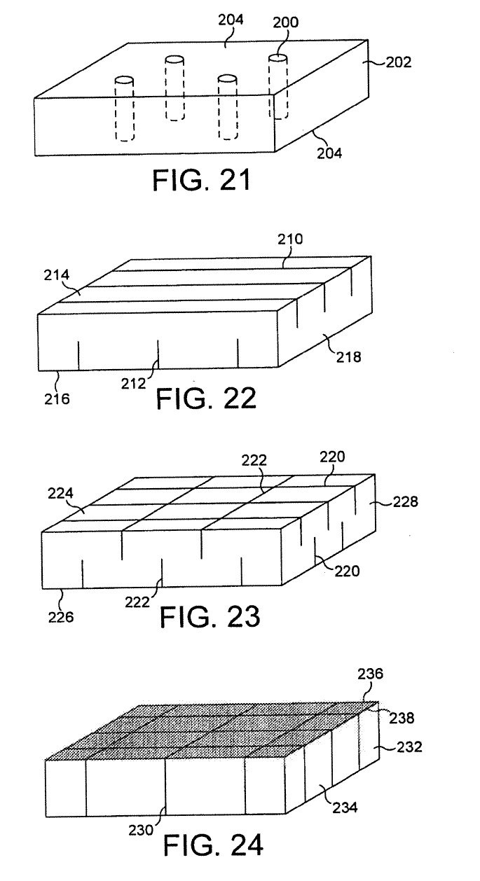

FIG. 21 is a perspective view of a structural element comprising a foam in accordance with a fourteenth embodiment of the present invention;

FIG. 22 is a perspective view of a structural element comprising a foam in accordance with a fifteenth embodiment of the present invention;

FIG. 23 is a perspective view of a structural element comprising a foam in accordance with a sixteenth embodiment of the present invention;

FIG. 24 is a perspective view of a structural element comprising a foam in accordance with a seventeenth embodiment of the present invention;

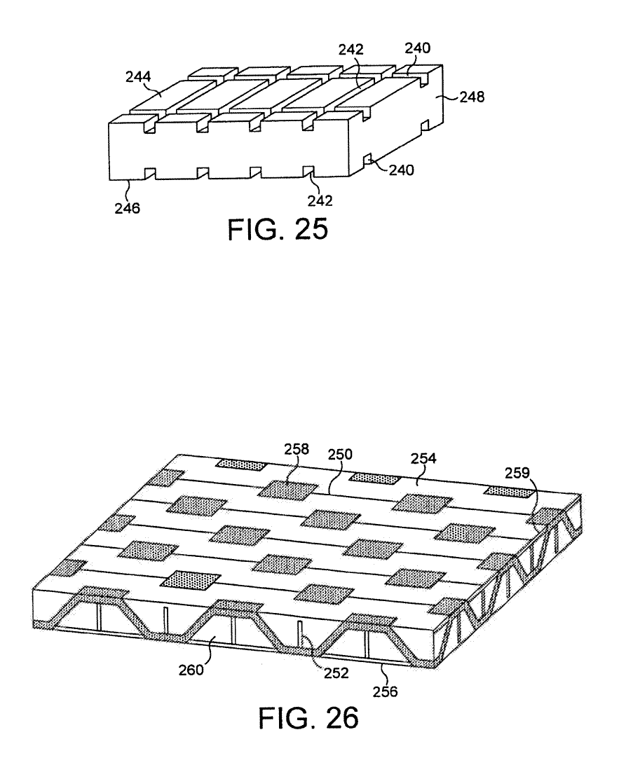

FIG. 25 is a perspective view of a structural element comprising a foam in accordance with a eighteenth embodiment of the present invention;

FIG. 26 is a perspective view of a structural element comprising a foam in accordance with a nineteenth embodiment of the present invention; and

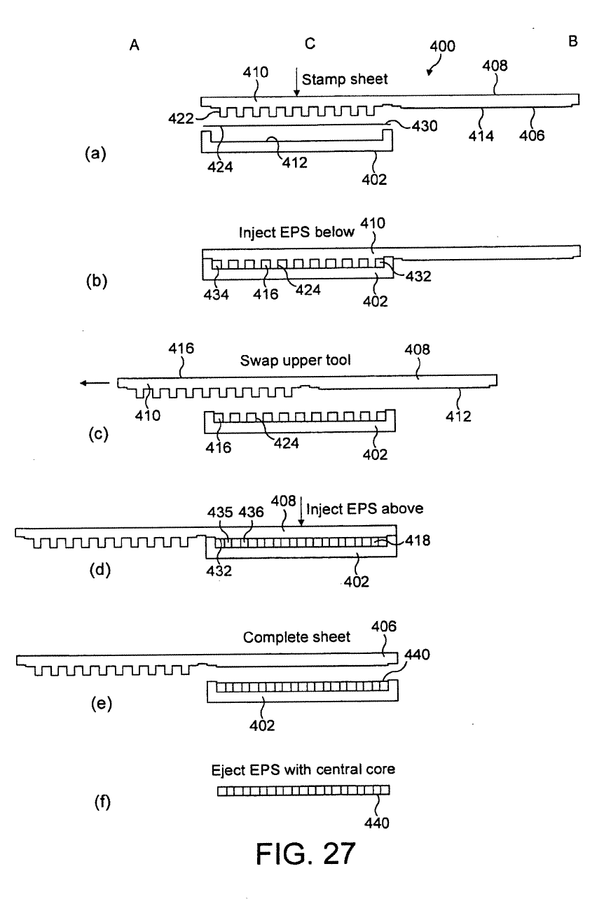

FIG. 27 shows schematically a sequence of steps in a method of manufacturing a reinforced foam core, using a moulding apparatus, in accordance with a further embodiment of the present invention.

Referring to FIG. 1, there is shown a schematic cross-section through a structural element 2 comprising a foam 4 in accordance with a first embodiment of the present invention. The structural element 2 comprises a planar sheet in which a central structural insert 6 extends generally in the plane of the sheet and is disposed between two opposed bodies 8, 10 comprising a foam, most preferably a closed cell foam.

According to the invention, a new composite foam core, formed from the bodies 8, 10, has been devised comprised of low density shaped regions, of the foam bodies 8, 10, at least partially surrounding a second higher modulus, higher strength region, the structural insert 6, which has a geometry selected to add targeted strength and stiffness to the foam. The provision of the structural insert 6 in the foam improves the strength and stiffness to weight ratio of a resultant foam core and lowers the cost of manufacturing a high performance foam core.

The bodies 8, 10 may be physically separated by the central structural insert 6 or alternatively they may be connected by foam connecting portions extending between the bodies 8, 10 through openings or through holes in the structural insert 6, thereby to form an integral foam core having the central structural insert 6. The bodies 8, 10 define opposite outer major planar surfaces 12, 14 of the sheet for attachment of fibre reinforced layers for the formation of a composite sandwich panel. In this way, the structural element 2 may comprise a central core layer of a sandwich panel between opposite outer skins of fibre reinforced composite material.

The structural element 2 is shown as a planar sheet but may have different shape, dimensions and cross-section.

The structural insert 6 extends generally in the plane of the sheet but includes portions that are inclined to the plane of the sheet and also inclined to the through-thickness direction of the sheet.

In the embodiment illustrated in FIG. 1, the structural insert 6 extends in a substantially zig-zag fashion through the through-thickness of the sheet. In the illustrated embodiment, the structural insert 6 is not wholly sandwiched within a central portion of the sheet between the outer foam bodies 8, 10, but rather lateral edges 16, 18 of the structural insert 6 extend as far as, and form part of, the outer major planar surfaces 12, 14 of the structural element 2. In other words, each outer surface 12, 14 of the structural element 2 consists of regions 20 of foam and regions 22 of the structural insert 22. Not only does this provide that the structural insert 2 extends entirely through the thickness of the sandwich structure, but also by providing regions 22 of the structural insert 2 on the outer surfaces 12, 14 of the structural element 2, when the structural element 2 is to be provided as a core of a sandwich structure having outer skins of fibre reinforced material, this can enhance the bonding between the outer skins to the central core, by providing areas of enhanced bonding between the fibre reinforced composite material and the exposed regions 22 of the structural insert 2.

FIG. 1 illustrates the structural element 2 in a schematic manner but this provision of a central structural insert between opposed foam bodies 8, 10 can be realised in a number of different ways in accordance with the invention, as described with reference to the embodiments discussed below.

In the embodiment of FIG. 2, the structural insert 24 comprises a sheet of interwoven fibres 26. The fibres 26 extend in orthogonal directions (i.e. a warp direction and a weft direction). When incorporated into the structural element 2 comprising the foam body, the fibres may extend in a 0° and 90° orientation or a +45° and −45° orientation. Each fibre 26 may have a circular cross-section. Each fibre 26 is preformed so as to have a non-linear longitudinal shape, namely to have portions that are inclined to the longitudinal direction of the fibres 26. In the illustrated embodiment, each fibre 26 has a longitudinally extending truncated zig-zag configuration with opposite and alternating outer lateral sections 28, parallel to the longitudinal direction, interconnected by alternating inclined sections 30. The outer lateral sections 28 may optionally extend as far as the outer surfaces 12, 14 of the opposed foam bodies 8, 10.

FIG. 3 discloses an alternative structural insert 32 comprising a solid moulded sheet 34. The sheet 34 has, for example, being thermoformed. The sheet 34 comprises a rectangular array of hollow truncated pyramids 36 impressed into the sheet 34. Each pyramid 36 has a planar top face 38, parallel to the plane of the sheet 34, and four faceted inclined side faces 40. The lower edges of the side faces 40 are interconnected by a rectangular outer periphery 42, parallel to the plane of the sheet 34. The peripheries 42 are interconnected to form a first lateral face 44 of the sheet 34 and the planar top faces 38 are spaced but form a second lateral face 46 of the sheet 34.

Alternatively, in the embodiment of FIG. 4, which is a modification of that of FIG. 3, the pyramids 48 are formed not in a rectangular array, but in an array with adjacent rows 50, 52, 54 being laterally offset with respect to each other so as to form a staggered array of rectangular truncated pyramids 48.

FIG. 5 shows an alternative embodiment of a structural insert 56 having a staggered array of generally truncated pyramids 58, but is modified as compared to FIG. 3 in that each pyramid 58 has four substantially rectangular orthogonally oriented facets 60 with additional substantially triangular facets 62 between each pair of adjacent substantially rectangular facets 60. Furthermore, the triangular facet 62 of each pyramid 58 is linked to an opposite triangular facet 62 of an adjacent pyramid 58 by a substantially rectangular face 64 which is parallel to the general plane of orientation of the structural insert 56. The underside of these faces 64, together with the upper planar truncated face 66 of each pyramid 58, define opposite lateral surfaces 67, 68 of the structural insert 56. These opposite lateral surfaces 66, 68 may be exposed in the outer surfaces 12, 14 of the structural element 2 after the structural insert 56 has been sandwiched between the opposed foam bodies 8, 10. The structural insert 56 is substantially symmetrical about a central plane orthogonal to the through thickness of the structural insert 56, and so when the structural insert 56 is sandwiched between two opposed identical foam bodies to form a foam core, the foam core may be correspondingly substantially symmetrical about a central plane orthogonal to the through thickness of the foam core.

FIG. 6 shows an exploded view of upper and lower foam bodies 70, 72 and a central structural insert 74. The structural insert 74 may also be composed of a closed cell foam, and in particular a higher density foam than the foam of the upper and lower foam bodies 70, 72. Again, as for the previous embodiment, the structural insert 74 comprises an array of truncated pyramids 76 but in an open-mesh structure to provide through holes 78 at each of the four corners of each pyramid 76 connecting between upper and lower faces of the insert 74. Each pyramid 76 consists of a truncated planar upper face 80 and four orthogonally oriented side faces 82, with the orthogonally oriented opposite side faces 82 of adjacent pyramids 76 connecting to a lower planar square plate 84 which, like the truncated face 80 of the pyramid 76, is parallel to the planar direction of the structural insert 74. When the structural insert 74 is disposed between the two foam bodies 70, 72 to form a sandwiched structural element 86, comprising a foam core 86, as shown in FIG. 7, the truncated faces 80 and the lower plates 84 form opposite regions 90, 92 of the structural insert 74 which are exposed on the respective opposite outer planar surfaces 94, 96 of the sandwiched structural element 86 for bonding to outer skins of fibre reinforced material (not shown). The structural element 86 is substantially symmetrical about a central plane orthogonal to the through thickness of the foam core 86.

Referring to FIGS. 8 and 9, a further embodiment of the structural element of the present invention is shown. In this embodiment, a first foam body 100 having a faceted pyramidal surface 102 comprising an array of truncated pyramids 104 is covered with a strip of elongate prepreg tape 106 in two orthogonal directions X and Y. FIG. 8(a) shows the tape 106 being laid in the X direction and FIG. 8(b) shows the tape 106 being laid in the Y direction. The tape 106 covers the major rectangular facets 108 and the planar upper face 110 of each truncated pyramid 104. The tape 106 also covers the lower planar square opening 112 between the adjacent truncated pyramids 104, opening 112 having the same dimensions as the face 110. This forms a continuous open rectangular grid of prepreg tape 106, contoured to the inclined facets 108 of the pyramids 104. Thereafter, the second foam body 114 is formed, for example by moulding, over the exposed prepreg tape 106 and the exposed surface areas of the first foam body 100 to form a composite combined structural element 116, which is a foam core, as shown in FIG. 9. In the structural element 116, exposed prepreg tape regions 118 are formed in an array on both opposed outer surfaces 120, 122 of the structural element 116. The structural element 116 is substantially symmetrical about a central plane orthogonal to the through thickness of the foam core.

The foam cores, incorporating the structural insert, of the various embodiments of the invention may be made by a variety of manufacturing techniques, for example:
(i) The structural insert, as a reinforcement for the foam core, may be placed into a mould and foam may be moulded around the reinforcement

In this manufacturing technique, a structural insert having through holes, such as in the embodiments of FIG. 2 or 6, optionally with a cellular structure as in the foam of FIG. 6, or having another porous structural insert such as a chopped fibre mat, is placed into a mould and a pre-expanded polymer process is used to form a foam around the structural insert. The through holes provide a structural insert which is porous to steam used in the foam moulding process. The structural insert may be made of a thermoplastic material. The thermoplastic material of the structural insert may be welded to the pre-expanded polymer during the moulding process. The foam moulding temperature may be selected to be matched the fusion temperature of the thermoplastic to achieve a weld or bond between the foam and the structural insert to maximise the structural properties of the reinforced foam core. The materials are selected to provide some welding. For example, polypropylene (PP) tends not to weld to expanded polystyrene (EPS) or expanded polystyrene/polyphenylene oxide (EPS/PPO) foam during the moulding process because the temperature is too low. However, the structural element may be thermally matched to the foam by selecting a thermoplastic such as polystyrene (PS) or high impact polystyrene (HIPS) for the structural element and EPS/PPO or PS foam. A higher performance coextruded thermoplastic structural element, such as a polyethylene/polycarbonate/polyethylene (PE/PC/PE) laminar structure may provide outer PE surfaces so that the lower melting point PE can form a weld to the EPS/PPO foam at the temperature of forming the EPS/PPO foam, and provide a higher structural performance insert by the use of a central polycarbonate (PC) layer. Alternatively, the foam may comprise pre-expanded polypropylene (EPP) in combination with a polypropylene (PP) structural element, but this combination is less preferred for a high rigidity core because PP is subsequently difficult to bond to and has a low modulus. This new foam is useful when a high specific strength and impact performance is required.

The creation of a foam with a fine cell size and no defects is also important to improve the mechanical properties of the foam, in particular the strength, and to prevent excess resin absorption into the foam body to keep the final density low.

Alternatively, the structural element may be coated, e.g. by dipping, with an adhesive which is used to bond the structural element to the pre-expanded polymer foam during the moulding process. An example is aramid paper dipped in epoxy resin incorporating a latent curing agent.

Another alternative method is to place a pre-made fibre reinforced resin truss, as disclosed in FIG. 2 as an example of a structural element, into a mould cavity and then pre-expanded polymer is used to foam around the structural element. This fibre reinforced resin truss would, for example be composed of a thermoplastic thermally compatible with the foam, or composed of a glass or carbon fibre reinforced thermosetting resin, such as an epoxy resin. This resin would either be cured initially and then coated with adhesive, for example by being dipped in adhesive, or coated in thermosetting resin, such as epoxy resin, for example by being dipped, to both impregnate the fibres with resin and to permit subsequent resin curing during the foaming process to cause adhesion of the structural element to the foam.
(ii) The foam bodies and the structural insert may be sequentially moulded so as progressively to mould the reinforced foam core using a pre-expanded polymer foam process

In this second manufacturing technique, a number of variants are possible: in each variant the pre-expanded polymer moulding process may be employed using a common base tool with a changing top tool to mould progressive layers of foam to form a final foam body.

Referring to FIG. 27, in a further alternative embodiment a shuttle tool method is provided for implementing the sequential moulding.

As shown in FIG. 27, the shuttle apparatus 400 includes a fixed lower mould tool 402 and an upper mould tool 406 which moves between two opposed sides A and B and has a central moulding position C. The upper mould tool 406 has two different laterally spaced mould parts 408,410. The lower mould tool 402 and a first upper mould part 408 have planar moulding surfaces 412, 414 for moulding a major outer surface of a respective lower and upper foam core part 416, 418. The second upper mould part 410 has a contoured moulding surface 422 for moulding a structural insert 424 having surfaces 426 which are orthogonal or inclined to the width direction of the mould cavity 428 for moulding the foam core incorporating the structural insert.

As shown in FIG. 27(a), initially a sheet 430 for forming the structural insert is stamped by the contoured moulding surface 422 of the second upper mould part 420 so as to have the required portions orthogonal or inclined to the planar direction of the sheet 430. The structural insert 424 is thereby formed.

In FIG. 27(b), an expanded foam body 434, for example of EPS, and optionally including PPO, is injected and moulded within the cavity 432 defined between the lower mould tool 402 and the second upper mould part 410. Therefore the lower foam core part 416 is formed having an upper surface bonded to the lower surface of the structural insert 424.

In FIG. 27(c), the upper mould tool 406 is laterally moved to swap the first upper mould part 408 having the planar moulding surface 412 for the second upper mould part 410.

In FIG. 27(d), the upper foam core part 418 is then formed as an expanded foam body 436, for example of EPS, and optionally including PPO, which is injected and moulded within the cavity 435 defined between the first upper mould part 408 and the structural insert 432, the expanded foam body 436 having a lower surface bonded to the upper surface of the structural insert 432.

This completes the formation of the reinforced foam core 440, as shown in FIG. 27(e), and the reinforced foam core 440 is then ejected from the mould defined by the tools 402, 406 as shown in FIG. 27(f).

This embodiment provides a convenient engineering solution which permits highly efficient production of foam bodies having a central separately but sequentially moulded reinforcing structural insert at a high production rate.

In one variant, low density foam bodies are formed from pre-expanded polymer, of density ranging typically from 20-45 g/L. This foam may comprise PS/PPO at a density of typically 30-40 g/L. Instead, lower cost standard PS, foamed down to a lower density of 20 g/L, may be employed, because the structural insert can provide the structural resistance to collapsing at elevated temperature during the composite laminate processing. The structural insert may be composed of higher density foam (100-300 g/L) to give the desired final density of the final core. Preferably, PS/PPO is used to achieve temperature resistance and higher mechanical properties.

Alternatively the higher density foam structural insert could be thermoformed, pressed or stamped from a sheet.

If the structural element includes EPS, optionally including PPO, for the foam bodies, it is preferred for the structural insert to have through holes or openings therethrough. Such through holes or openings would allow the steam employed in the production of the EPS to pass through the whole foam body and the structural insert to improve the expansion of the EPS and weld of the pre-expanded beads of EPS to the structural insert. To use this higher density material for the structural insert, a smaller thickness of the structural insert forming the central reinforcing region would be used.

In these processes, it is possible to form substantially any desired shape for the outer foam bodies and the central structural insert, particularly the three dimensional shape and orientation of the interfaces between these layers of the composite core. The embodiments may utilise only two top tools, for sequentially moulding the lower and upper foam bodies, but three or more top tools may be employed when additional layers are to be moulded. Alternatively the moulded part could be removed from a mould and placed into a new tool for subsequent over-moulding. However, it is more convenient to use a single base mould with a changing top tool machine because the foam remains hot and so it is easier to achieve each subsequent welding or fusion cycle.

The structural inserts of embodiments of FIGS. 3 to 5 may be utilised in such a sequential progressive moulding method, and such embodiments also provide structural inserts with +/−45° shear enhanced structure.

A composite foam core incorporating the structural inserts of embodiments of FIGS. 3 to 7 may be produced by: first moulding a low density foam layer to give the desired three dimensional geometry on the upper surface of the lower foam layer; moulding a second higher modulus, higher strength region thereon to form the structural insert; then encapsulating the structural insert with a third low density foam layer to complete the foam core. The geometry of the upper surface of the lower foam layer, which is mirrored in the geometry of the lower surface of the upper foam layer, is chosen to orientate the higher performance material of the structural insert in the +/−45° directions to enhance the shear properties of the foam core.

The foam cores of the embodiments of FIGS. 10 to 20 may be made using this variant of the progressive moulding technique. The progressive moulding can provide a central low density foam-containing core with high density skins, and also high density webs and/or fingers, also of foam, extending in a through thickness direction between the skins.

Referring to FIGS. 10 and 11 which show one embodiment of a foam core, an initial moulded high density foam body 150 comprises a lower skin 152 and integral therewith a rectangular array of spaced rectangular blocks 154 extending upwardly from the skin 152. The blocks 154 are separated by orthogonal channels 156 forming a rectangular grid. The blocks 154 comprise “fingers”. A low density foam body 158 is subsequently moulded into the channels 156 so as to fill the channels 156, and provide a common upper surface 160 for the foam bodies 150, 158. Finally, a high density foam upper skin 162 is moulded onto the upper surface 160, to form the foam core 164. The blocks 154 of high density foam interconnect the high density foam skins 152, 162. The resultant foam core 164 has high shear strength and shear modulus.

The embodiment of FIG. 12 is a modification of the embodiment of the foam core of FIGS. 10 and 11, in which the blocks 166 or “fingers” are triangular rather than rectangular in plan. The channels are mutually inclined in three directions, for example 0°, 60° and 120°. Alternatively, the channels are mutually inclined at 0°, 45° and 90°. Referring to FIGS. 13 and 14 which show another embodiment of a foam core, an initial moulded high density foam body 170 comprises a lower skin 172 and integral therewith a rectangular grid 174 extending upwardly from the skin 172. The grid 174 comprises orthogonal webs 176 defining rectangular cavities 178 therein. A low density foam body 180, comprising a plurality of spaced blocks 182, is subsequently moulded into the cavities 178 so as to fill the cavities 178, and provide a common upper surface 184 for the foam bodies 170, 180. Finally, a high density foam upper skin 186 is moulded onto the upper surface 184, to form the foam core 188. The webs 176 of high density foam interconnect the high density foam skins 172, 186. The resultant foam core 188 has high shear strength and shear modulus.

FIGS. 15 and 16 illustrate a modification of the embodiment of FIGS. 13 and 14, in which the webs are not orthogonal, defining a rectangular grid, but instead the webs 192, 194, 196 extend in three directions, 0°, 60° and 120°. Alternatively, the webs are mutually inclined at 0°, 45° and 90°. This further enhances the shear strength and shear modulus of the foam core 198.

For the embodiments of FIGS. 10 to 16, such a composite foam core is produced by: first moulding an integral high density thin skin with fingers or web; a second low density in-fill is then moulded to fill the voids. A third high density top skin is then added to give a balanced construction. The high density skin helps with skin wrinkling and localised impact damage but is not so suitable for thinner cores (typically below about 20 mm) because the high density skin reduces the remaining weight available for the interior structural elements.

FIGS. 17 and 18 illustrate a modification of the embodiment of FIGS. 13 and 14, in which the skins are not formed. The initial moulded foam body comprises a rectangular grid 200 of high density foam webs 202 and the cavities 204 therebetween are in-filled with low density foam, forming blocks 206 between the webs 202. This forms a foam core 208 that does not have foam skins but instead has the same cross-section in it's through thickness direction.

FIGS. 19 and 20 illustrate a modification of the embodiment of FIGS. 17 and 18, in which the high density foam webs are not orthogonal, defining a rectangular grid, but instead the webs 210, 212, 214 extend in three directions, 0°, 60° and 120°. Alternatively, the webs are mutually inclined at 0°, 45° and 90°. This further enhances the shear strength and shear modulus of the foam core 216.

For the embodiments of FIGS. 17 to 20, such a composite foam core is produced by: first moulding an integral high density web and then a second low density foam in-fill is then moulded to fill the voids. It is preferred to use the high density material to form the continuous web.

The creation of a foam with a fine cell size and no defects is also important to improve the mechanical properties of the foam, in particular the strength, and to prevent excess resin absorption into the foam body to keep the final density low.
(iii) The foam bodies, and optionally the structural insert, may be moulded as separate mouldings and subsequently bonded together

This third manufacturing technique may use the same geometrical structures for the structural insert and the interfaces with the foam bodies as for the second manufacturing technique, and the embodiments of FIGS. 3 to 7 in particular. However, instead of progressive moulding, by using a common base tool and changing the top tool thereby to overmould the structural insert and the upper foam onto the underlying previously moulded upper surface, the two low density foam parts are moulded separately and individually.

The mouldings are designed to provide a targeted cavity to accept some form of fibre composite reinforcement as opposed to a high density foam or a thermoformed sheet. The creation of a foam with a fine cell size and no defects is also important to improve the mechanical properties of the foam, in particular the strength, and to prevent excess resin absorption into the foam body to keep the final density low.

One variant of this method employs pre-preg layers, for example as tapes, as disclosed with respect to the embodiment of FIGS. 8 and 9.

For example, a mixture of pre-preg tape and/or fibre reinforced resin is applied to an upper contoured surface of a first pre-formed moulded foam body as shown in FIG. 8. The complementary lower contoured surface of a second pre-formed moulded foam body is placed on the top and the foam sandwich is either;
(a) Press consolidated to leave the pre-preg uncured to provide more drape in use. The foam is cured during the component cure. In this case the pre-preg may contain an additional blowing agent. This is to compensate for draping the foam over considerable curvature and the pre-preg partly foams to compensate for the cavities created when opening up the foam body during the fit to extreme curvature.
(b) Press consolidating and curing to give a rigid foam core

In each case, the foam core has a central fibre-reinforced structural insert having a contoured configuration, oriented along the 0°, 90° or +45°/−45° directions, to provide enhanced shear strength and shear modulus.

In a modification of the embodiment of FIGS. 8 and 9, in a further embodiment instead of pre-preg layers, dry fibre layers are laid up onto the contoured surface and a binder is used to retain the fibres in the required orientation, for example extending orthogonally along the inclined facets of the pyramidal shaped. Subsequently, after the two outer foam bodies have been assembled together with their complementary contoured surfaces interlocking, resin is introduced into the cavity, so as to wet out the fibres, in a resin transfer moulding (RTM) technique, preferably a VARTM technique.

In this method, fibres are applied between the two foam mouldings to form the outer foam bodies which have been previously independently moulded. The fibres may comprise any suitable fibre for the required application, for example glass, carbon or aramid fibres, or any other natural or synthetic material known for use in fibre reinforce composite materials. The assembly, of the opposed outer foam bodies and a central fibre layer, is placed into a mould, and then resin, for example thermosetting resin, such as epoxy resin, is injected under pressure to impregnate the fibre layer and bond the resin-impregnated fibre layer to the opposite foam bodies. The resin is typically formulated to:
(a) cure to give a rigid cross-linked fibre reinforced thermoset plastic
(b) contain a mixture of low temperature and elevated temperature catalytic curing agents to first stage and build the resin from a low viscosity liquid to a semi-solid texture (pre-preg resin). This would give the core some increased flexibility to fit to the required geometry. This would then cure in the subsequent elevated cure of the composite material.
(c) contain a mixture of low temperature and elevated temperature catalytic curing agents and additional blowing agent. This is to compensate for draping the foam over considerable curvature and the pre-preg partly foams to compensate for the cavities created when opening up the foam body during the fit to extreme curvature.
(d) the resin and hardener or monomer and catalyst are selected to only chain extend the resin to form a thermoplastic resin to allow later thermoforming and increase the elongation

Alternatively, no fibres are placed between the two foam mouldings to form the outer foam bodies, but instead a cavity is provided therebetween. The injected resin may contain chopped fibre and/or other filler to inject into the cavity between the two mould bodies. This also forms a fibre-reinforce resin layer bonding together the two opposed foam bodies.

Instead of prepreg tapes, employing reinforcing fibres impregnated (fully or partially) by a resin, in particular a thermosetting resin such as an epoxy resin, such as in the embodiment of FIGS. 8 and 9, thermoplastic tapes may be used. These may contain electrically conductive elements, such as metal wires or carbon fibres, to facilitate resistance welding of the foam to the central layer forming a structural insert by passing an electrical current through the electrically conductive elements thereby heating the two opposed foam surfaces, causing welding of those surfaces to the central layer.

Alternatively an ultrasonic welding procedure could be used during application of the tape to the foam surface. Such localised ultrasonic welding would prevent extended heating and consequential damage to the foam. Ultrasonic welding uses a high energy depth focused short time interval, high temperature weld. It is therefore possible to weld a high structural performance, or multi-layered, thermoplastic structural insert to the opposed foam bodies.

The embodiment of FIG. 8 is a particularly preferred embodiment because the cavity between the foam bodies contains the most targeted shear property enhancing volume for the structural element and facilitates low cost tape laying.

In a first manufacturing method, uni-directional pre-preg tapes may be employed to form the shear properties enhancing central layer. The first low density foam body is loaded into a tool. Pre-preg unidirectional tapes are applied in the principle directions to the upper contoured surface, as for FIG. 8. An adhesive layer is then placed over the entire, or just remaining exposed foam, upper contoured surface. The second low density foam body is placed on top of the upper contoured surface. The lower contoured surface of the second low density foam body is modified, if necessary, to allow for the additional thickness created at each node where the fibres cross over. The assembly of the upper and lower foam bodies with the central pre-preg layer therebetween is either press consolidated or cured.

In a modified method, the unidirectional tapes may be used in a RTM (resin transfer moulding) process. The first low density foam body is loaded into a tool. Unidirectional tapes are applied in the principle directions, e.g. the orthogonal directions corresponding to the lines of symmetry of the side faces of the contoured surface, as for the previous embodiment. The second low density foam body is placed on top. This has been modified to allow for the additional thickness created at each node where the fibres cross over. The tool is closed and low viscosity resin is injected to impregnate the fibres.

In a further modified method, long fibre reinforcement may be used together with RTM (Resin transfer Moulding). The first low density foam body is loaded into a tool. A premade fibre perform, or fabric, or a fibre placement machine is used to place long fibre reinforcement onto the contoured foam upper surface. The second low density foam body region is placed on top. This has been modified to allow for the additional thickness created at each node where the fibres cross over. The tool is closed and low viscosity resin is injected to impregnate the fibres.

In a further modified method, short fibre reinforcement may be used together with RTM (Resin transfer Moulding). Instead of a fibre pre-form the resin is filled with a mixture of short fibre and/or filler and the resin is injected into the cavity.

Alternatively, a thermoplastic tape or fibre reinforced tape may be ultrasonically or resistance welded to the upper contoured surface of the lower foam body.

The previous methods have employed bands or tapes which form a discontinuous surface for the structural insert, because the tapes are mutually spaced to provide an oriented open grid of the reinforcing fibrous tapes. The following methods in contrast feature a continuous surface for the structural insert.

One method is a fibre reinforced RTM process. The first low density foam body region is loaded into a tool. Preferably for ease of manufacture a random fibre mat is placed on top to facilitate drape to the undulating surface with options for additional directional fibre placement. The second low density foam body is placed on top. The tool is closed and low viscosity resin is injected to impregnate the fibres as before.

Another method is a pre-preg process. The first low density foam body is loaded into a tool. Preferably for ease of manufacture a random fibre mat is placed on top to facilitate drape to the undulating surface with options for additional directional fibre placement. The second low density foam body is placed on top. The tool is closed and either consolidated or cured as before

The embodiments of FIGS. 10 to 20 may be modified by providing fibre-reinforced foam grids.

The foam cores of the embodiments of the manufacturing techniques of the invention summarised above as (i), (ii) and (iii) may be modified to assist any VARTM process subsequently employed to bond a fibre-reinforced resin layer onto the opposed outer surfaces of the foam core.

Referring to FIGS. 21 to 26, the foam core of any of the previous embodiments may additionally be provided with holes and/or or channels to provide pathways to promote resin flow for the VARTM (Vacuum Assisted Resin Transfer Moulding) process after manufacture or moulded during the manufacturing process.

FIG. 21 illustrates drill holes 200, extending entirely through the thickness of the foam core 202. The drill holes 200 are circular and form a regular array extending orthogonally from one or each major surface 204 of the foam core 206.

FIG. 22 illustrates knife slits 210, 212 in the upper and lower surfaces 214, 216 of the foam core 218. The knife slits 210 in the upper surface 214 are parallel to each other and extends in a longitudinal direction but are orthogonal to the transverse knife slits 212, also parallel to each other, in the lower surface 216.

FIG. 23 is a modification of FIG. 22, with knife slits 220, 222 in the upper and lower surfaces 224, 226 of the foam core 228. The knife slits 220, 222 extend orthogonally and are present in both the upper and lower surfaces 224, 226. The slits 220, 222 in the upper surface 224 are laterally offset relative to the slits 220, 222 in the lower surface 226. Each slit may extend through a desired proportion of the thickness of the core 228, for example through from 50 to 95% of the core thickness so as to render the core flexible about a radius having an axis parallel to the slits.

FIG. 24 provides orthogonal cuts 230 extending entirely through the foam core 232, to form an array of adjacent rectangular blocks 234, with a scrim material 236 being bonded to the upper surface 238 of the blocks 234 to maintain a unitary foam core 232.

FIG. 25 provides orthogonal grooves 240, 242 on both the upper and lower surfaces 244, 246 of the foam core 248.

FIG. 26 shows illustrates knife slits 250, 252 in the upper and lower surfaces 254, 256 of the foam core 258, which corresponds to the foam core of FIG. 7. The knife slits 250 in the upper surface 254 are parallel to each other and extend in a longitudinal direction but are orthogonal to the transverse knife slits 252, also parallel to each other, in the lower surface 256. The knife slits 250, 252 both extend substantially through the entire thickness of the foam core 258 and terminate in the respective outer skin 259, 260 which is opposite to the outer skin 260,258 from which the slit 250, 252 extends inwardly into the foam core 258.

The embodiment of FIG. 26 is a preferred format for wind turbines and other items with low curvature features. The cuts assist the core being wrapped or bent around a radius having an axis parallel to the plane of the foam core. This therefore assists drape of the core, as well as resin infusion. The narrow grooves formed by a knife cut may be in the 0° direction on the top surface and 90° direction on the bottom surface. Accordingly, each slit may extend through a desired proportion of the thickness of the core 258, for example through from 50 to 95% of the core thickness so as to render the core flexible about a radius having an axis parallel to the slits. Typically, for a 25 mm thick reinforced core, the slits are 23 mm deep (leaving a 2 mm thickness of foam) and are mutually spaced by 50 mm.

This format is advantageous over the double cut (Staggered knife cut in the 0/° 90° directions on both the top & bottom surfaces) and various other groove patterns as it provides sufficient drape with sufficient flow channels but at a reduced surface area and groove volume compared to these other formats. This results in lower resin absorption but good subsequent laminate quality.

The foam cores of the present invention may be used in any application requiring structural foam cores, patrticularly in composite materials—marine structures, civil engineering structures, wind turbines blades, etc.

The foam cores of the present invention can provide the advantages of low cost and low weight.

The preferred embodiments of the present invention provide a foam core in which, to provide particularly enhanced improvements in shear stress and sear modulus, a dual density foam core is provided, with the high density foam being configured to be aligned, particularly in the +45/−45 directions to improve shear properties.

Some embodiments, in particular the dual density web and finger designs described above that do not have such aligned high density foam, may not exhibit any significant improvement in specific shear strength, although the incorporation of a fibre reinforced composite in the form of a structural insert into each design improves the specific structural properties due to the higher stiffness and strength to weight ratio of the fibres as compared to the foam.

The present invention is illustrated further by the following non-limiting Examples.

### EXAMPLE 1

This example produced a foam core having a rectangular cavity (0/90) web according to the embodiment of FIGS. 17 and 18.

An 84 g/L 25 mm thick foam sheet was made by:
Foaming a continuous 0/90 web with 12.5 mm thick walls, 25 mm high, with a even pitch in the x and y directions of 37.5 mm from 120 g/L PS/PPO pre-expanded bead such that 25×25×25 mm deep rectangular void areas were formed within the grid.
Foaming the 25×25×25 mm deep rectangular void areas within the grid with 30 g/L PS/PPO foam

This produced a PS/PPO foam with an overall density of 84 g/L and thickness of 25 mm with a high density reinforcing grid structure.

### EXAMPLE 2

This example produced a foam core having a rectangular cavity (0/90) web with high density skins according to the embodiment of FIGS. 13 and 14.

An 84 g/L 25 mm thick foam sheet was made by:
Foaming a continuous 2 mm thick base plate with an integral 0/90 web with 12.5 mm thick walls from 110 g/L PS/PPO pre-expanded head such that 25×25×21 mm deep rectangular void areas were formed with the grid
Foaming the 25×25×21 mm deep rectangular void areas within the grid with 40 g/L PS/PPO foam
Foaming a continuous 2 mm thick top plate from 110 g/L PS/PPO pre-expanded bead on top of the first and second materials

This produced a PS/PPO foam with an overall density of 84 g/L, and a total thickness of 25 mm. The foam core contains both a high density inner grid structure and high density top and bottom faces.

### EXAMPLE 3

This example produced a foam core having a rectangular cavity (0/90) web with high density skins according to the embodiment of FIGS. 13 and 14.

An 84 g/L 10 mm thick foam sheet was made by:
Foaming a continuous 2 mm thick base plate with an integral 0/90 web with 12.5 mm thick walls from 100 g/L PS/PPO pre-expanded bead such that 25×25×6 mm deep rectangular void areas were formed with the grid
Foaming the 25×25×6 mm deep rectangular void areas within the grid with 40 g/L PS/PPO foam
Foaming a continuous 2 mm thick top plate from 100 g/L PS/PPO pre-expanded bead on top of the first and second materials

This produced a PS/PPO foam with an overall density of 84 g/L, and a total thickness of 10 mm. The foam contained both a high density inner grid structure and high density top and bottom faces. The high density portions in the thinner foam section were reduced in density compared to Example 2 to maintain the average density of the foam body.

### EXAMPLE 4

This example produced a foam core having a triangular cavity (0/45/90) web according to the embodiment of FIGS. 19 and 20.

An 84 g/L 25 mm thick foam sheet was first made by:
Foaming a continuous 0/90/45 web with 12.5 mm thick walls with a even pitch in the x and y directions of 87.5 mm from 117 g/L PS/PPO pre-expanded bead
Foaming the 75 mm×37.5 mm×25 mm deep triangular void areas within the grid with 40 g/L PS/PPO foam.

This produced a PS/PPO foam with an overall density of 84 g/L and thickness of 25 mm with a high density reinforcing grid structure.

### EXAMPLE 5

This example produced a foam core having a central structural insert according to the embodiment of FIGS. 6 and 7.

An 84 g/L 25 mm thick foam sheet was made by:
Foaming a corrugated first moulding with 40 g/L PS/PPO pre-expanded bead using a first mould top plate and a base plate.
Foaming a selective second layer consisting of bands of 25 mm wide, 5 mm thick foam in both the x and y plan view directions on top of the first foam layer. The pitch between the bands was 90 mm in both the sheet x and y directions. This second foam layer was formed from 260 g/L PS/PPO pre-expanded bead. The first and second moulds were designed such that an undulating +7-45 pattern was created in the foam cross section and this reinforcing foam layer was symmetrical through the centreline of the finished foam body.
Foaming a third layer from 40 g/L PS/PPO foam on top of the first and second layers to complete the sheet to have a constant combined thickness of 25 mm.

This produced a PS/PPO foam with an overall density of 84 g/L and thickness of 25 mm containing a symmetrical high density reinforcing structure designed to increase the shear strength and modulus of the foam.

### EXAMPLE 6

This example produced a foam core having a central structural insert according to the embodiment of FIGS. 6 and 7.

A 60 g/L 25 mm thick foam sheet was made by:
Foaming a corrugated base plate with 40 g/L PS/PPO pre-expanded bead using the first mould top plate.
Foaming a selective second layer consisting of bands of 25 mm wide, 5 mm thick foam in both the x and y plan view directions on top of the first foam layer. The pitch between the bands was 90 mm in both the sheet x and y directions. This foam was formed from 140 g/L PS/PPO pre-expanded bead. The first second moulds were designed such that an undulating +/−45 pattern was created in the foam cross section and this reinforcing foam layer was symmetrical through the centreline of the finished foam body.
Foaming third layer from 40 g/L PS/PPO foam on top of the first and second layers to complete the sheet to have a constant combined thickness of 25 mm.

This produced a PS/PPO foam with an overall density of 60 g/L and thickness of 25 mm containing a high density reinforcing structure designed to increase the shear strength and modulus of the foam.

### EXAMPLE 7

This example produced a foam core having a central structural insert according to the embodiment of FIGS. 6 and 7.

A 60 g/L 25 mm thick foam sheet was made by:
Foaming a corrugated base plate with 25 g/L PS/PPO pre-expanded bead using the first mould top plate.
Foaming a selective second layer consisting of bands of 25 mm wide, 5 mm thick foam in both the in both the x and y plan view directions on top of the first foam layer. The pitch between the bands was 90 mm in both the sheet x and y directions. This foam was formed from 200 g/L PS/PPO pre-expanded bead. The first second moulds were designed such that an undulating +/−45 pattern was created in the foam cross section and this reinforcing foam layer was symmetrical through the centreline of the finished foam body.
Foaming third layer from 25 g/L PS/PPO foam on top of the first and second layers to complete the sheet to have a constant combined thickness of 25 mm.

This produced a PS/PPO foam with an overall density of 60 g/L and thickness of 25 mm containing a high density reinforcing structure designed to increase the shear strength and modulus of the foam.

### EXAMPLE 8

This example produced a foam core having a central structural insert according to the embodiment of FIGS. 6 and 7.

An 84 g/L 25 mm thick foam sheet was made by:
Foaming a corrugated first moulding with 40 g/L PS/PPO pre-expanded bead using the first mould top plate.
Foaming a selective second layer consisting of bands of 25 mm wide, 8 mm thick foam in both the x and y plan view directions on top of the first foam layer. The pitch between the bands was 90 mm in both the sheet x and y directions. This second foam layer was formed from 175 g/L PS/PPO pre-expanded bead. The first and second moulds were designed such that an undulating +/−45 pattern was created in the foam cross section and this reinforcing foam layer was symmetrical through the centreline of the finished foam body.
Foaming a third layer from 40 g/L PS/PPO foam on top of the first and second layers to complete the sheet to have a constant combined thickness of 25 mm.

This produced a PS/PPO foam with an overall density of 84 g/L and thickness of 25 mm containing a symmetrical high density reinforcing structure designed to increase the shear strength and modulus of the foam.

### EXAMPLE 9

This example produced a foam core having a central structural insert according to the embodiment of FIGS. 8 and 9.

An 84 g/L 25 mm thick foam sheet was made by:
Foaming a corrugated first moulding with 32 g/L PS/PPO pre-expanded bead.
Foaming a corrugated second moulding with 32 g/L PS/PPO pre-expanded bead designed to leave a selected cavity (25 mm wide x0.5 mm deep on the webs and 25 mm wide×1.0 mm deep on the nodal points) between the first and second mouldings when fitted together.
Applying strips of 25 mm wide 600 gsm uni-directional glass fibre 32% resin weight epoxy pre-preg from a resin such as Gurit WE92/EGL600/32% in both the x and y plan view directions to the first moulding. The pitch between the tapes was 90 mm in both the sheet x and y directions. The shape of the first moulding was such that an undulating +/−45 pattern was created in the foam cross section and the reinforcing tapes were symmetrical about the foam centre including an allowance for the increased thickness at the nodal intercepts of the tapes.
Applying an additional 250 gsm of WE92 epoxy resin to the foam surface not covered by pre-preg material to bond the subsequent layer of foam.
Applying this second foam moulding to foam and pre-preg assembly and consolidating the layers to give a constant thickness foam body.

This produced a PS/PPO foam with an overall density of 84 g/L and thickness of 25 mm containing a fibre reinforced +/−45 reinforcing structure designed to increase the shear strength and modulus of the foam.

The foam body was subsequently cured to give a rigid high strength foam structure. This curing step could be carried out before or during the manufacture of the composite component.

### EXAMPLE 10

This example produced a foam core having a central structural insert according to the embodiment of FIGS. 8 and 9.

A 76 g/L 25 mm thick foam sheet was made by:
Foaming a corrugated first moulding with 32 g/L PS/PPO pre-expanded bead
Foaming a corrugated second moulding with 32 g/L PS/PPO pre-expanded bead designed to leave a selected cavity (25 mm wide×0.5 mm deep on the webs and 25 mm wide×1.0 mm deep on the nodal points) between the first and second mouldings when fitted together.
Applying strips of 25 mm wide 500 gsm carbon glass fibre 37% resin weight epoxy pre-preg from a resin such as Gurit SE84LV/HEC500/37% in both the x and y plan view directions. The pitch between the tapes was 90 mm in both the sheet x and y directions. The shape of the first moulding was such that an undulating +/−45 pattern was created in the foam cross section and the reinforcing tapes were symmetrical about the foam centre including an allowance for the increased thickness at the nodal intercepts of the tapes.
Applying an additional 250 gsm of SE84LV epoxy resin to the foam surface not covered by pre-preg material.
Applying this second foam moulding to the foam and pre-preg assembly and consolidating the layers to give a constant thickness foam body.

This produced a PS/PPO foam with an overall density of 76 g/L and thickness of 25 mm containing a fibre reinforced +/−45 reinforcing structure designed to increase the shear strength and modulus of the foam.

### EXAMPLE 11

This example produced a foam core having a central structural insert, according to the embodiment of FIGS. 8 and 9, using an RTM process to produce a cured epoxy resin of a glass fibre reinforced composite structural insert.

An 84 g/L 25 mm thick foam sheet was made by:
Foaming a corrugated first moulding with 32 g/L PS/PPO pre-expanded head.
Foaming a corrugated second moulding with 32 g/L PS/PPO pre-expanded head designed to leave a selected cavity (25 mm wide×0.5 mm deep on the webs and 25 mm wide×1.0 mm deep on the nodal points) between the first and second mouldings when fitted together.
Applying 25 mm wide strips of dry 600 gsm uni-directional glass fibre in both the x and y plan view directions to the first moulding. The pitch between the tapes was 90 mm in both the sheet x and y directions. The shape of the first moulding was such that an undulating +/−45 pattern was created in the foam cross section and the reinforcing tapes were symmetrical about the foam centre including an allowance for the increased thickness at the nodal intercepts of the tapes.
Placing the assembly into a matched mould and closing the mould to 25 mm.
Applying a vacuum then injecting epoxy resin under pressure such as Gurit Prime 20LV to impregnate the fibre and bond the two layers of foam

Allowing the resin to cure to give a PS/PPO foam with an overall density of 84 g/L and thickness of 25 mm containing a fibre reinforced +/−45 reinforcing structure designed to increase the shear strength and modulus of the foam.

### EXAMPLE 12

This example produced a foam core having a central structural insert, according to the embodiment of FIGS. 8 and 9, using an RTM process, with staging, to produce a cured epoxy resin of a glass fibre reinforced composite structural insert.

An 84 g/L 25 mm thick foam sheet was made by:
Foaming a corrugated first moulding with 32 g/L PS/PPO pre-expanded bead.
Foaming a corrugated second moulding with 32 g/L PS/PPO pre-expanded bead designed to leave a selected cavity (25 mm wide×0.5 mm deep on the webs and 25 mm wide×1.0 mm deep on the nodal points) between the first and second mouldings when fitted together.
Applying strips of 25 mm wide of dry 600 gsm uni-directional glass fibre in both the x and y plan view directions to the first moulding. The pitch between the tapes was 90 mm in both the sheet x and y directions. The shape of the first moulding was such that an undulating +/−45 pattern was created in the foam cross section and the reinforcing tapes were symmetrical about the foam centre including an allowance for the increased thickness at the nodal intercepts of the tapes.
Placing the assembly into a matched mould and closing the mould to 25 mm.
Applying a vacuum then injecting an epoxy resin containing both a room temperature and elevated catalytic curing agent selected to increase the viscosity of the epoxy resin via a staging process to a high viscosity resin containing non reacted epoxy groups for later elevated temperature curing.

Allowing the resin to stage at a temperature below the activation of the catalytic curing agent gave a PS/PPO foam with an overall density of 84 g/L and thickness of 25 mm containing a fibre reinforced +/−45 reinforcing structure designed to increase the shear strength and modulus of the foam and give improved drape of the foam body.

The foam body may be subsequently cured to give a rigid high strength foam structure. This curing could be before or during the manufacture of the composite component.

1-76. (canceled)

77. A core for a composite laminated article, the core comprising a sheet having a sandwich structure comprising a pair of outer foam bodies and a central structural insert therebetween, the structural insert including portions that are inclined to the plane of the sheet and to the through-thickness direction of the sheet, wherein the central structural insert comprises a grid composed of first and second sets of parallel tapes of fibre reinforcement, the first and second sets being mutually inclined.

78. A core according to claim 77 wherein the structural insert extends in a substantially zig-zag fashion through the through-thickness of the core.

79. A core according to claim 77 wherein the central structural insert has projecting portions which extend to a major outer surface of a respective outer foam body.

80. A core according to claim 77 wherein the structural insert comprises a contoured sheet which has opposite major surfaces which are contoured three-dimensionally.

81. A core according to claim 80 wherein each major surface of the sheet has an array of projections and depressions.

82. A core according to claim 81 wherein the projections and depressions are substantially pyramidal.

83. A core according to claim 82 wherein the substantially pyramidal projections and depressions each have mutually orthogonally arranged inclined side faces.

84. A core according to claim 82 wherein the pyramidal shape is truncated to form a planar top surface.

85. A core according to claim 84 wherein the planar top surface is level with an outer surface of the core.

86. A core according to claim 77 wherein the central structural insert comprises a continuous sheet.

87. A core according to claim 77 wherein the central structural insert comprises a sheet with a plurality of through holes.

88. A core according to claim 77 wherein the fibre reinforcement comprises one or more prepreg layers, the prepreg layers comprising fibres at least partially impregnated with resin.

89. A core according to claim 77 wherein the foam core and the structural insert are symmetrical about a central plane thereof.

90. A core according to claim 77 wherein the sheet is planar or curved.

91. A core according to claim 77 wherein the or each foam is a closed cell foam.

92. An assembly for producing a composite laminated article, the assembly comprising the core of claim 77 sandwiched between opposed layers of fibre or prepreg layers, the prepreg layers comprising fibres at least partially impregnated with resin.

93. A method of making a core for a composite laminated article, the method comprising the steps of:
(a) moulding a first foam body having a first contoured surface;
(b) moulding a second foam body having a second contoured surface, the first and second contoured surfaces being complementarily shaped;
(c) interlocking the first and second contoured surfaces to define a contoured cavity extending therebetween over the opposed surfaces; and
(d) forming a central structural insert in the cavity which is bonded to the first and second contoured surfaces, wherein the central structural insert comprises a fibre-reinforced resin and wherein the central structural insert comprises a grid composed of first and second sets of parallel tapes, the first and second sets being mutually inclined.

94. A method according to claim 93, wherein the central structure insert is formed from prepreg material, the prepreg material comprising fibres at least partially impregnated with resin.

95. A method according to claim 94, wherein the prepreg material is disposed on at least one of the contoured surfaces prior to interlocking step (c).

96. A method according to claim 93, wherein the fibre-reinforced resin is formed from dry fibres disposed on at least one of the contoured surfaces prior to interlocking step (c) and in step (d) resin is introduced into the cavity.

97. A method according to claim 93, wherein the fibre-reinforced resin is formed from fibrous reinforcement disposed within the cavity in step (c) and liquid resin introduced into the cavity in step (d) by resin transfer moulding.

98. A method according claim 93, wherein the fibres of the fibrereinforced resin form a contoured grid.

99. A method according to claim 93, wherein the central structural insert comprises a thermoplastic material.

100. A method according to claim 99, wherein the thermoplastic material is adhesively bonded or fusion welded to the first and second contoured surfaces.

101. A method according to claim 93 wherein the structural insert extends in a substantially zig-zag fashion through the through-thickness of the core.
